(19) United States
(12) Patent Application Publication
(10) Pub. No.: US 2002/0148330 A1
(43) Pub. Date: Oct. 17, 2002

(54) Structure of a hammer

(76) Inventor: Yin-Hae Huang, Feng-Yuan City (TW)

Correspondence Address: Yin-Hae Huang, P.O. Box 697, Feng-Yuan City 420, TW

(21) Appl. No.: 09/834,798

(22) Filed: Apr. 11, 2001

(51) Int. Cl. B25D 1/00

(52) U.S. Cl. 81/23

(57) ABSTRACT

A structure of a hammer includes a hammer-head engaged with a handle which is combined by a pair identical halves to form a nail chamber in rear end, a tunnel extending from the nail chamber to a slit in front end of the handle and intercepted by a vertical slot into which is a control button to control the nail from going through the tunnel, an exit in front end of the handle beneath the slit, a magnet disposed under the exit and a cylinder cavity in the back of the exit for disposing a counterblow mechanism therein. The hammer of the present invention further have a nil magazine and a trumpet tube for serving small sized nails.

### BACKGROUND OF THE INVENTION

The present invention relates to hammers and more particularly to a structure of a hammer which can automatically support the nails and previously drives the nail to a target into which it nails.

Normally, a hammer includes only a handle and a hammer-head. When drives a nail to a target, the user grasps the nail with one hand and drives the hammer with another. Recently, a new structure hammer is appeared in the market (a shown in FIG. 1) can automatically support the nail from the hollow handle which hammer comprises a hollow handle 10, a hammer-head 11, a nails chamber 12 in the rear end of the handle 10 covered by a lid 101, a tunnel 15 extending through the center of the handle 10 communicating to the chamber 12 and the hammer-head 11, a button 16 biased by a spring 17 having a hole 161 to control the nail 13 from passing through the tunnel to the hammer-head 11. In operation, turns the hammer-head 11 downward and simultaneously presses the button 16 inward permitting a nail 13 passing through the tunnel 15 until that the nail 13 is attracted by a magnet 18 inside the hammerhead 11. Then drives the nail 13 slightly into a working largest and then uses the hammer-head 11 to continuously drive the nail 13 into the largest. This type of hammer has a great disadvantage that the user is difficult to aim the nail 13 at the exact largest.

### SUMMARY OF THE PRESENT INVENTION

The present invention has a main object to provide a structure of a hammer which automatically supports the nail on one by one basis and the nail at the front of the hammer-head can exactly aim at the working largest and partially entered into the largest by a counterblow mechanism before it is completely drove into the largest by the hammer-head.

Accordingly the hammer comprises a hammer-head, a hollow handle which is combined by a pair identical halves each has a nail chamber in rear end closed by a openable lid, a tunnel extending forward from the chamber and controlled by a slidable button which controls the nail from going through to reach to the hammer-head, a cylinder cavity in front end of the handle to receive a counterblow mechanism and a magnetic in the front end of the handle beneath an exit of the nail. So that when the nail stops at the exit attracted by the magnet, the counterblow mechanism will drive the nail partially into the working largest and then completely nailed into the largest by the hammer-head. The hammer-head further has an uprooting means at lower end.

The present invention will become more fully understood by reference to the following detailed description thereof when read in conjunction with the attached drawings.

### BRIEF DESCRIPTION OF THE DRAWINGS

FIG. 1 is a sectional view to show hammer according to a prior art,

FIG. 2 is a perspective view to show a hammer according to the preferred embodiment of the present invention,

FIG. 3 is an exploded perspective view of FIG. 2,

FIG. 4 is a sectional view to show the inside of the hammer of the present invention,

FIG. 5 is a sectional view to show a nail in the tunnel about to pass through the control button,

FIG. 6 is a sectional view to show that the nail is passed through the control button,

FIG. 7 is a sectional view to show that the counterblow mechanism conducts to the head of the nail,

FIG. 8 is a sectional view to show that the counterblow mechanism under a pressure from the nail,

FIG. 9 is a sectional view to show that the plunger of the counterblow mechanism enters into the cavity of the cylinder means,

FIG. 10 is a sectional view to show that the reaction force of the cylinder means to counterblow the nail which is partially driven into the working largest,

FIG. 11 is a plane view to show that the uprooting means removes the nail out of the working target,

FIG. 12 is a sectional view to show a nail magazine of the present invention,

FIG. 13 is a sectional view to show that the nail magazine and trumpet tube are mounted into the hammer of the present invention, and

FIG. 14 is a sectional view taken along line 13-13 of FIG. 13.

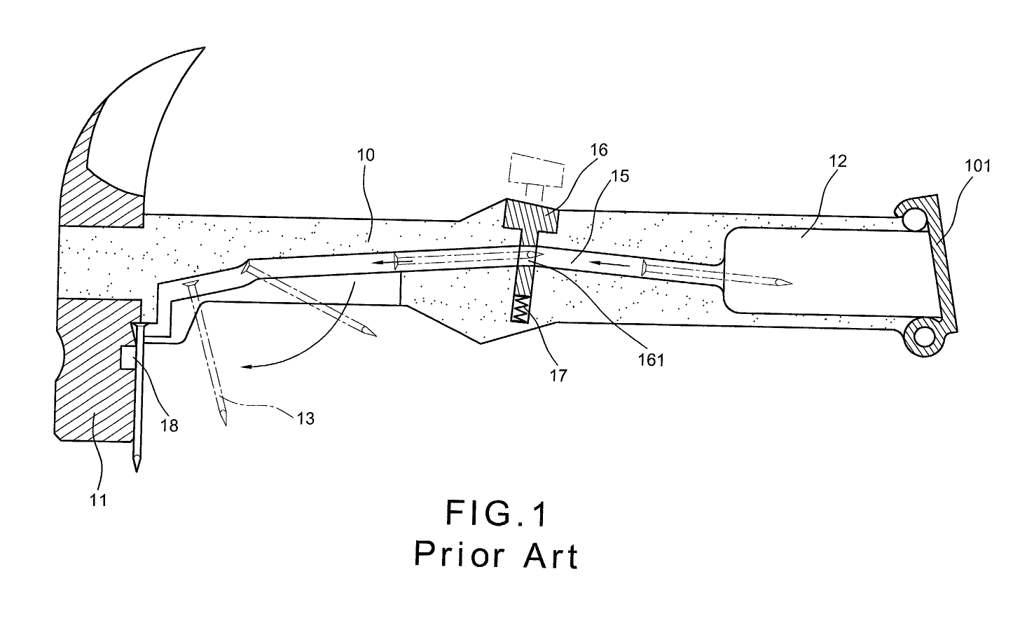

### DETAILED DESCRIPTION OF THE PREFERRED EMBODIMENT

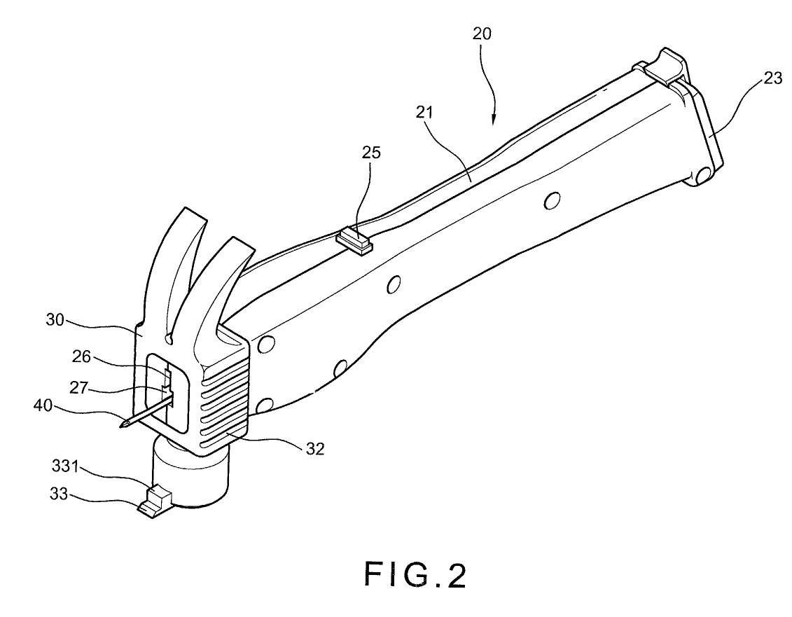

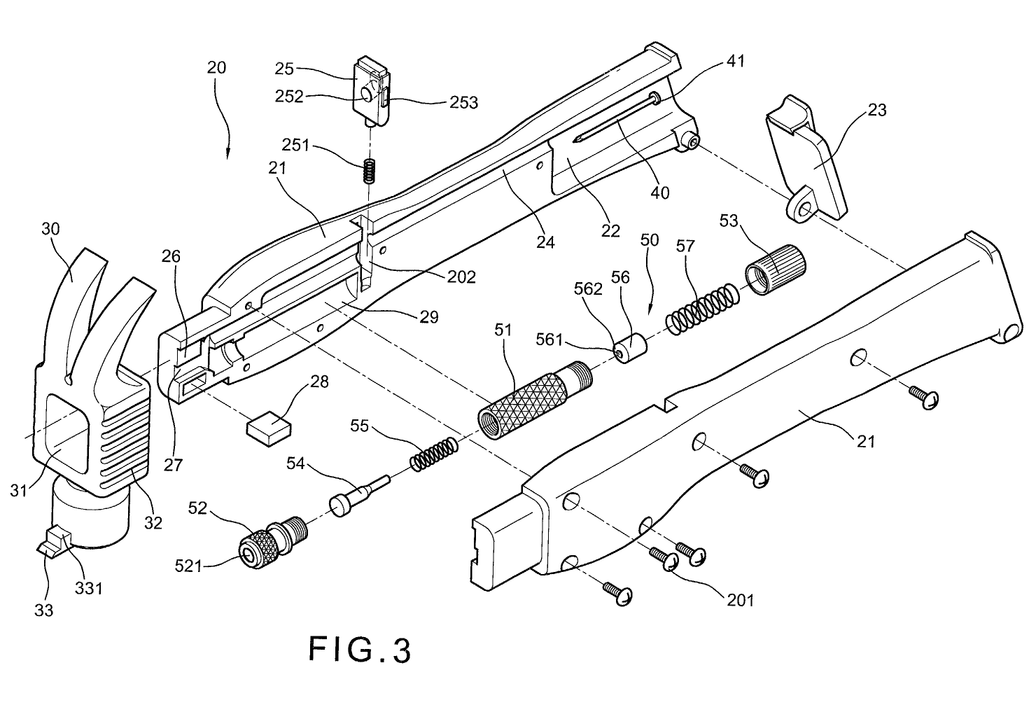

With reference to FIGS. 2, 3, 4 and 7, the hammer of the present invention comprises generally a handle 20 combined by a pair of identical halves 21 and secured by screws 201 and a hammer-head 30.

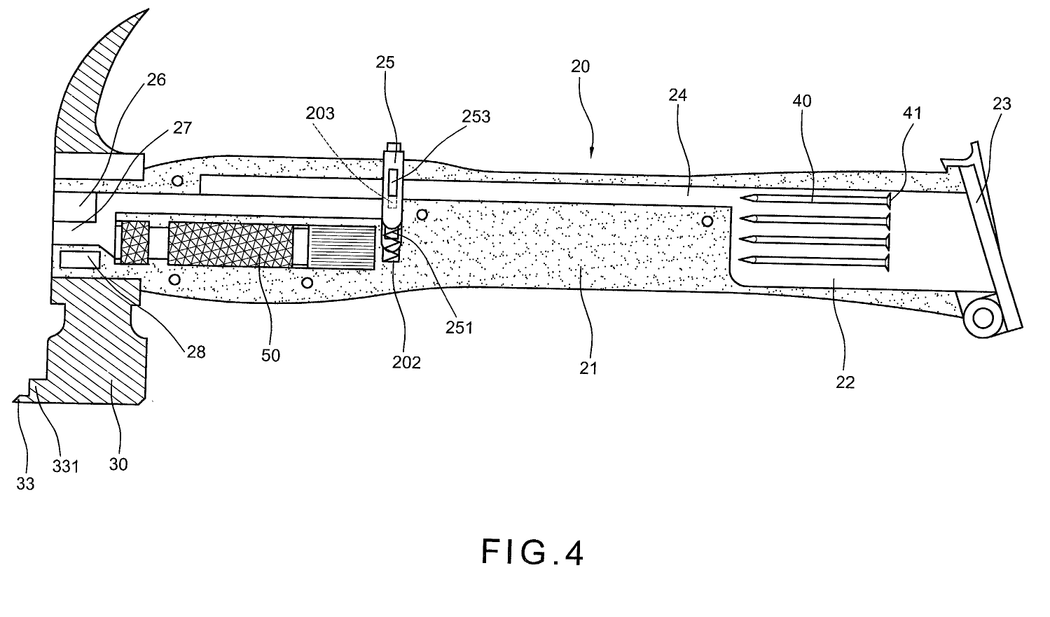

The handle 20 has a front end frictionally engaged into an eye 31 of the hammer-head, a nail chamber 22 formed in the rear end openably covered by a lid 23 which is pivoted to the rear end, a tunnel 24 inside the handle 20 extending forward from the nail hammer 22 to the slit 26 and intercepted by a vertical slot 202 at the middle of the handle 20, a control button 25 slidably inserted into the vertical slot 202 biased by a spring 251 (as show in FIG. 4) and having a pair of protrusions 253 on lateral sides for securing the button 25 in the vertical slot 202 and a bevel central hole 252 so that when presses the button 25 downward to have the bevel hole 252 engaged with the tunnel 24, the nail can be passing through the bevel hole 252 and going to an exit 27 in front end of the handle 20 and when the button 25 is released to slide upward, the nail could not pass through, a slit 26 above the exit 27 communicating to the tunnel 24 and a magnet 28 positioned beneath the exit 27 such that when a nail 40 enters into the slit 26 from the tunnel 24, its head 41 could not pass through the slit 26 but the nail may totally drop down into the exit 27 and transversely attracted by the magnet 28, and a cylindrical cavity 29 formed in the back side of the exit 27 parallel to the exit 27 for engaging a counterblow mechanism 50 therein.

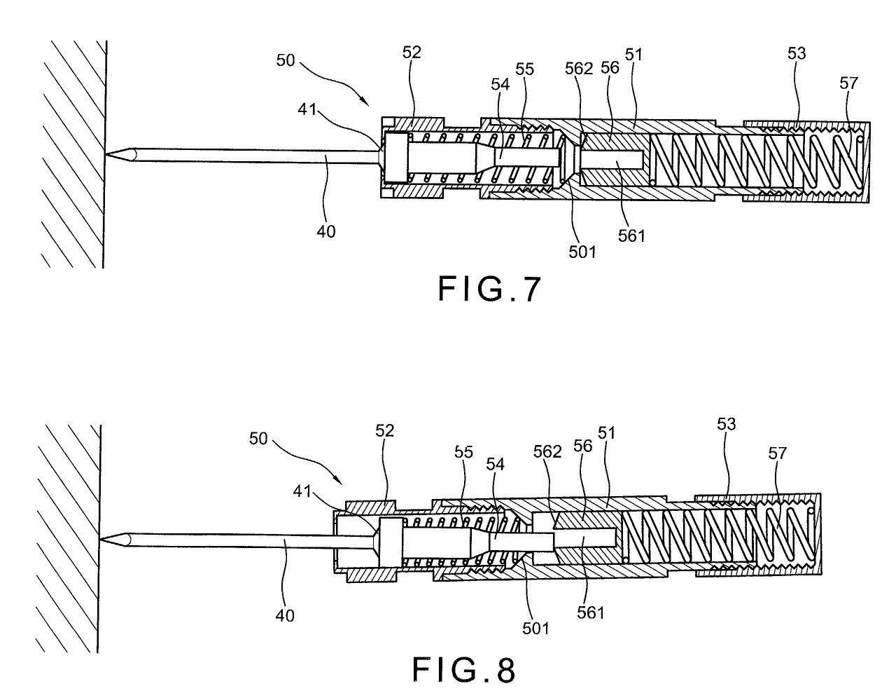

The counterblow mechanism 50 is composed of a tube 51 having inner threads in front end and outer threads on rear end, a nipple 52 having a nail hole 521 in front end engageable with the head 41 of a nail 40 and an outer threads on rear end engaged with the inner threads of the tube 51 which further has an inner flange 501 (as shown in FIGS. 7 and 8), a cap 53 having inner threads engaged with the outer threads of the tube 51 and biased by a strong spring 57 and a cylinder 56 which including a central cavity 562 and a circular groove 561 and a plunger 54 engaged into the nipple 52 biased by a spring 55. The plunger 54 has a little eccentric in structure therefor enabling to stop against the groove 561 of the cylinder 56. The cap 53 can be swinging to adjust the elastic force of the strong spring 57 and hence the spring 55.

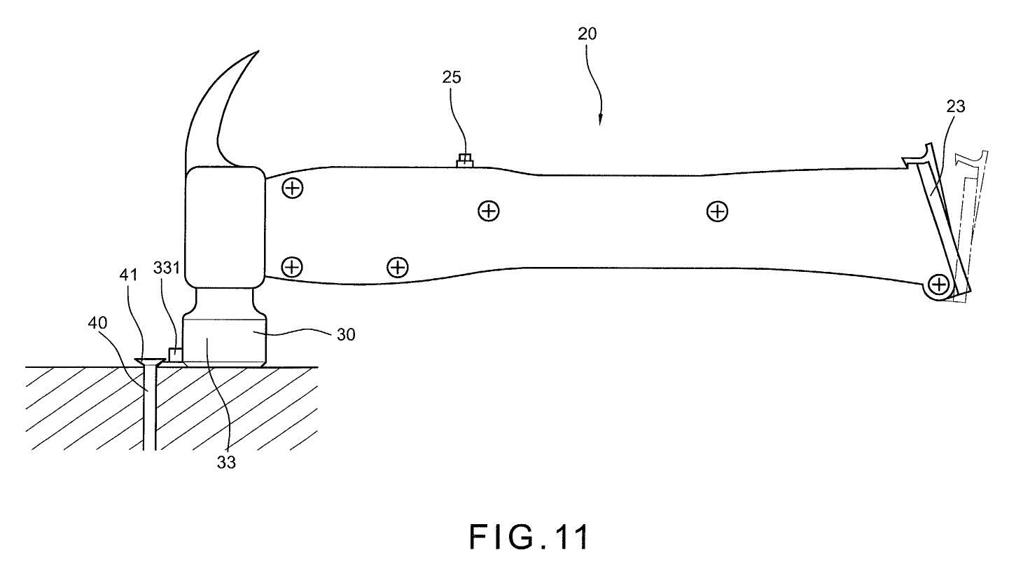

The hammer-head 30 except the eye 31, further has transverse spline 32 on two lateral sides and a bevel block 33 on the front of the poll and reinforced by a reinforcement 331. The bevel block 33 can pry open a nail 40 which is already drove into the working target (as shown FIG. 11).

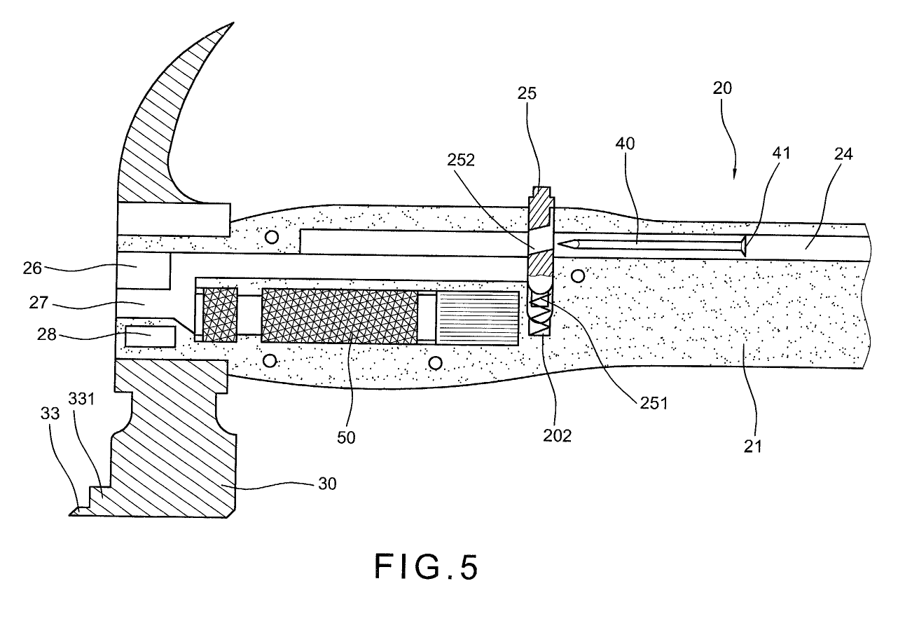

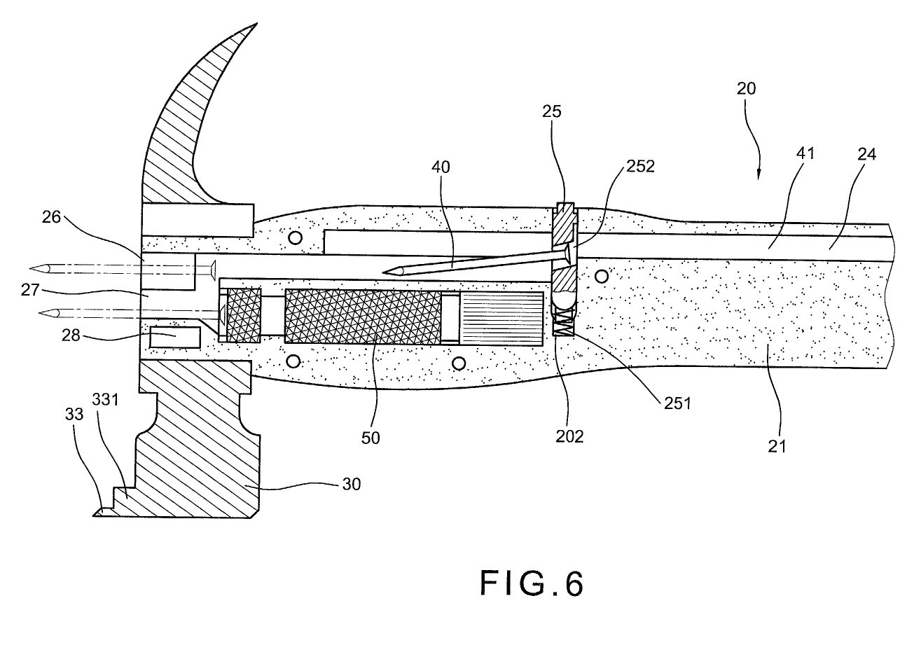

In operation, load a plurality nails 40 into the nail chamber 22 making the head 41 of the nails 40 toward real end of the hand 20 and dose the lid 23. Then turn the hammer-head downward and simultaneously press the button 25 downward, one of the nails 40 will be going through the funnel 24 and the bevel central hole 252 reaching to the slit 26 and then the nail 40 drops down into the exit 27 because of the attraction of the magnet 28, simultaneously the head 41 of the nail 40 automatically engages with the nail hole 521 of the nipple 52 (as shown in FIGS. 4, 5 and 6).

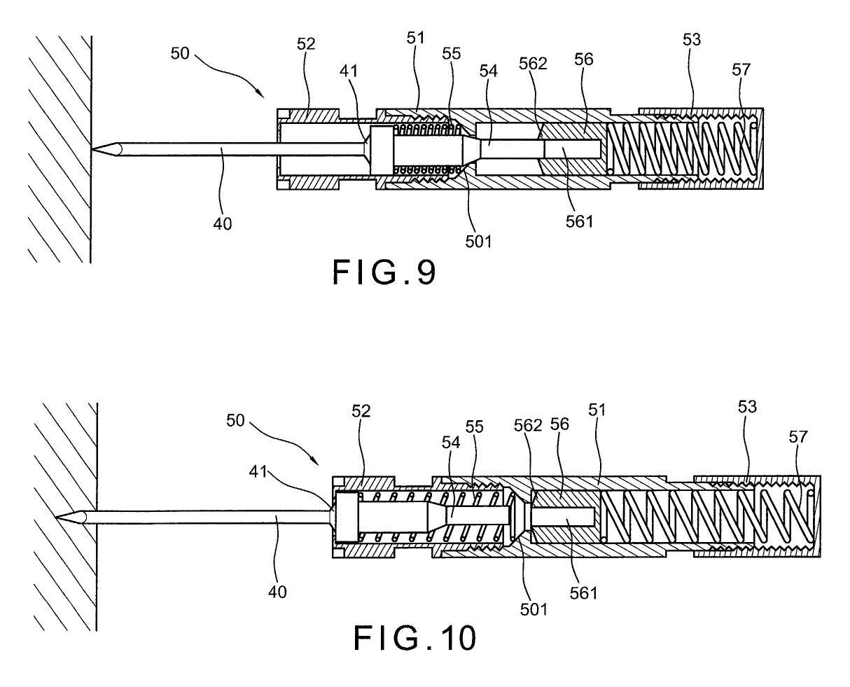

Referring to FIGS. 7 and 8, to aim the nail at a working target and to press it in, the plunger 54 of the counterblow mechanism 50 under the pressure of the head 41 of the nail slides backward and stops against the circular groove 562. Continuous pressure makes the plunger 54 entering into the cavity 561 of the cylinder 56, the resilience of the springs 55 and 57 becomes a counterblow force to strike the plunger 54 to immediately turn forward to press the nail 40 partially entering into the target (as shown in FIGS. 9 and 10).

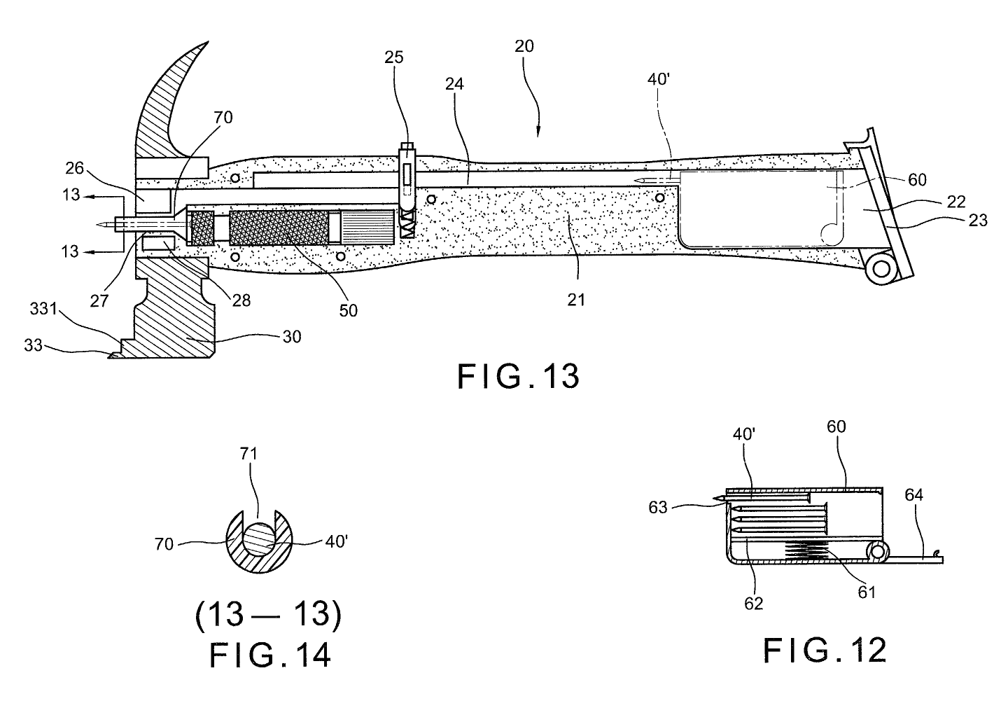

Referring to FIGS. 12, 13 and 14, if the size of the nail 40′ is small than that of the nail 40, a nail magazine 60 and a trumpet tube 70 are useful to offset this defect. The nail magazine 60 similar to the magazine of shot gun comprises a spring 61, a pressure plate 62, an exit 63 and a cover 64. The nail magazine is covered and disposed into the nail chamber 22 after loading a certain number of the nails 40′ which are automatically entered into the tunnel 24 on one by one basis (as shown in FIG. 13). The trumpet tube 70 is flexible to be easily insert into the exit 27 of the hammer and has a slit 71 in the top for receiving a nail 40′ from the slit 26of the hammer. Once the nail 40′ entered into the trumpet tube 70, it will be balanced without swinging to and from. Further the trumpet tube may be is different size.

The hammer of the present invention is very suitable to use in the carpenter job such as decoration engineering and more convenient and reliable than the prior art hammer.

The specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A structure of a hammer comprising:
a hammer-head having an eye in center, a transverse spline on lateral sides and a bevel block reinforced by a reinforcement on a front side of a poll thereof;
a handle combined with a pair identical halves to form a nail chamber is rear end releasibly covered by lid, a tunnel inside the handle extending from the nail chamber into a slit in front end of the handle and intercepted by a vertical slot at a middle portion, a control button slidably disposed into the vertical slot biased by a first spring means, said control button having a pair of protrusions on lateral sides and a bevel central hole for permitting a nail passing through, an exit in the front end beneath the slit, a magnet disposed under the exit and a cylinder cavity formed in a front end of the handle parallel and communicating to the exit, said handle having front end frictional engaged into the eye of the hammer-head;
a counterblow mechanism disposed into the cylinder cavity of the handle comprising a tube having inner threads in front end, outer threads on rear end and an inner flange, a nipple having a central bore and outer threads on rear end engaged with inner threads of the tube, a plunger disposed between the nipple and the tube therein biased by a second spring means, a cylinder slidably disposed into the rear end of the tube and biased by strong spring, said cylinder having a central cavity and a circular groove in front end, and a cap having inner threads adjustably engaged with the outer threads of the tube.

2. The hammer as recited in claim 1 wherein said plunger is structurally eccentric.

3. The hammer as recited in claim 1 further includes a nail magazine for serving small sized nails and engageable into the nail chamber of the handle, said nail magazine comprising a spring plate a sliding plate biased by the spring plate, an exit and a cover.

4. The hammer as recited in claim 1 further includes a flexible trumpet tube engageable into the exit of the handle having a slit in top for receiving a small sized nail therein.

5. The hammer as recited in claim 4 wherein the trumpet tube may be in different size to serve for different sized nails.
